(19) United States
(12) Patent Application Publication
(10) Pub. No.: US 2007/0269640 A1
(43) Pub. Date: Nov. 22, 2007

(54) Antistatic Paper And Panel

(75) Inventor: Leonhard Schitter, Hallwang (AT)

Correspondence Address: RANKIN, HILL, PORTER & CLARK, LLP, 925 EUCLID AVENUE, SUITE 700, CLEVELAND, OH, 44115-1405, US

(73) Assignee: M. KAINDL, Wals, Salzburg (AT)

(21) Appl. No.: 11/834,730

(22) Filed: Aug. 7, 2007

Related U.S. Application Data
(62) Division of application No. 10/990,749, filed on Nov. 17, 2004.

(30) Foreign Application Priority Data
Nov. 26, 2003 (DE) 20318290

(51) Int. Cl. B32B 3/00

(52) U.S. Cl. 428/195.1

(57) ABSTRACT

A décor paper for use as a surface on a floor panel has applied to it quaternary ammonium compounds in a resin mixture. The resin may be urea or melamine resin, and the mixture may also include abrasion-resistant particles such as corundum. The mixture applied to the paper provides it with antistatic properties, so that, when used on a floor panel, very little static electricity is generated by people walking on it. The floor panel is made up by the paper, attached to a one surface of a carrier, with a corresponding paper attached to the opposing surface.

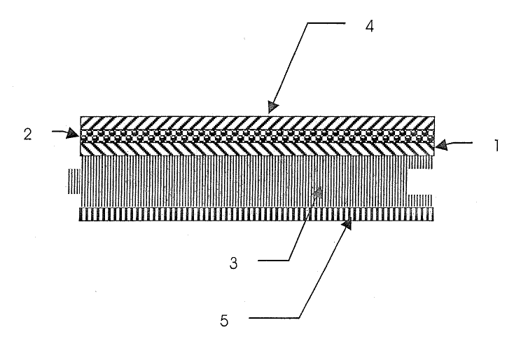

The invention relates to a paper and a flooring panel made with this paper. The panel comprises a carrier, to which the paper is attached. The paper is generally printed and is then referred to as décor paper. A corresponding or counteracting element, preferably in the form of a paper, is generally provided beneath the carrier. Such panels have coupling elements at the sides. Panels of this kind can therefore be connected together without glue, as described, for example, in WO 01/94721 A1.

The décor paper may have applied to it abrasion-resistant particles made from corundum, aluminium oxide or silicon carbide, so that the paper is suitable for walking on. The abrasion-resistant particles are embedded in a resin matrix. For reasons of cost, melamine resins to which urea resins can be added are preferred. Methods for the manufacture of a décor paper for flooring panels are already known from U.S. Pat. No. 4,940,503, WO 00/44576 A1, WO 00/44984 A1 and WO 02/066265.

The counteracting paper can be attached to the carrier by means of a resin. In this case, urea resin is the preferred resin, because resistance to moisture is less important on the underside. Accordingly, expensive additives such as melamine resin are not required.

A board made from a timber material is often used as the carrier. At present, HDF is the preferred carrier material, because this material provides structural stability and can be easily processed. A manufacturing method for a panel of this kind is described in DE 20210718 U1.

However, a carrier for a laminate flooring can also consist of several paper layers, which have been glued together, as disclosed, for example, in WO 96/27721.

A laminate flooring of this kind can become charged with static electricity when it is walked on, especially in the presence of a low relative atmospheric humidity. An atmospheric humidity lower than 50% is considered low in the sense of the invention. Under unfavourable conditions, a person can become charged with a body-voltage up to 25,000 Volts.

When approaching earthed elements such as heating elements, discharge sparks occur which can be perceived by sensitive persons at voltages above 2 kV. With higher charges, the discharge can be painful. Electronic devices such as computers and electronic circuits can be damaged as a result of charges of this kind.

To combat this problem, panels with so-called “astatic” properties are available. According to the standard EN 1815, a panel can be designated as “astatic” if the possible body-voltage charge is below 2000 volts.

The object of the present invention is to create a décor paper and a panel with antistatic properties.

This object is achieved by a paper with the features of the independent claim. Advantageous embodiments are defined in the dependent claims.

According to the invention, a paper, for example, a décor paper or an overlay paper can be provided with a resin mixture, which contains quaternary ammonium compounds, preferably quaternary amines. In order to fulfil the requirements of the standard EN 1815, the proportion of quaternary ammonium compounds in the resin mixture is at least 10% by weight Since quaternary ammonium compounds are relatively expensive, a proportion of 20% by weight should not be exceeded.

The paper can be fed in the form of a paper web through a mixture, which contains the named quaternary ammonium compounds alongside urea resin and/or melamine resin. The paper impregnated in this manner is dried and, after a given time, compressed with a carrier, preferably with a supply of heat.

Alternatively, the mixture may, for example, be sprayed onto the paper.

The result is a panel with improved antistatic properties by comparison with a panel, in which the paper has been impregnated with other conventional resins. In fact, as a result of the quaternary ammonium compounds, the electrical conductivity is increased in the surface region of the floor covering. This leads to a reduction in the body-voltage imported to persons walking on the floor.

According to the prior art described above, abrasion-resistant particles can be applied to the décor surface. To achieve cost-favourable production, the mixture already contains abrasion-resistant particles and indeed especially aluminium oxide/corundum, because this material is generally hardly visible and therefore hardly impairs the visual appearance of the décor. Accordingly, in one operational process, abrasion-resistant particles are applied to the décor paper at the same time as improving the antistatic properties.

It is advantageous if the décor paper is first impregnated in the mixture with the abrasion-resistant particles, and the mixture is then at least partially removed, for example, by means of a scraper, from the underside of the décor paper. As a result, the abrasion-resistant particles are applied predominantly to one side of the décor paper. This is advantageous, because for the purpose required, the abrasion-resistant particles are needed only on one side, namely on the side with the decoration.

If the mixture contains abrasion-resistant particles, it may advantageously contain additional viscosity-increasing substances such as cellulose derivatives. As a result, the abrasion-resistant particles are held in suspension in the mixture in an improved manner. Accordingly, a good, even distribution of the abrasion-resistant particles is achieved on the surface of the paper.

Finally, an overlay is impregnated in a mixture, which contains a resin such as urea resin and/or melamine resin. Moreover, this mixture also contains substances which increase the electrical conductivity, that is to say, especially the named quaternary ammonium compounds. Once again, the proportion is approximately 10 to 20% by weight.

The carrier, décor paper and overlay are compressed together to form a board. A counteracting paper disposed on the underside of the carrier is also generally compressed.

As an alternative, abrasion-resistant particles such as corundum may be applied to one side of the overlay. In this manner, the carrier, the décor paper, the overlay and, optionally, a counteracting paper are compressed together in such a manner that the abrasion-resistant particles are disposed between the décor paper and the overlay. The décor is then visible on the surface of the panel.

An embodiment of the invention is illustrated in the accompanying drawings, of which the single FIGURE shows a section through a flooring panel.

In the FIGURE, a paper 1, onto the upper surface of which a decoration has been printed, is impregnated with a mixture by dosing. The mixture comprises a urea resin and/or a melamine resin, quaternary amines, cellulose fibres and powdered corundum. The average grain size of the corundum is between 60 μm and 120 μm. The proportion of quaternary amines in the mixture is approximately 15% by weight. With the assistance of dosage rollers, this décor paper 1 is provided with the mixture in a metered manner and indeed with approximately 150 g/m² (measured after drying). The mixture is scraped from the underside of the décor paper 1 with a scraper. The abrasion-resistant particles 2 remain predominantly on the upper surface. Finally, the décor paper 1 with the application of abrasion-resistant particles is dried in a fluid-bed drier.

The dried décor paper 1 is attached by its underside to an 8 mm thick HDF board 3. A so-called “overlay” 4 impregnated with a mixture of melamine resin and quaternary amines is placed over the decorative paper. A paper 5 impregnated with urea resin is placed beneath the HDF board as a corresponding or counteracting paper. The papers 1 and 5 as well as the overlay 4 are compressed together with the HDF board at temperatures of 180° C. to 220° C.

By sawing and milling, panels with the dimensions 1400 mm×200 mm and with coupling means are manufactured from the board 3 with the compressed papers. The result is shown schematically in the FIGURE.

A floor covering was made for test purposes using seven panels manufactured according to the example described above. The test area was approximately 1400 mm×1400 mm. The antistatic properties were tested in accordance with the standard EN 1815 (1997), Method A. The floor covering was disposed on an insulating rubber mat. The measurements were carried out under two different climate conditions. For this purpose, the sample was placed in a climate chamber, in which it was possible to walk over the panels.

One test series was carried out at 23° C. and 50% relative humidity, and another test series was carried out at 23° C. and 25% relative humidity. The trial participants wore sandals with rubber soles as specified in the test document. In another test, the participants wore town shoes with rubber soles. The commercially available test equipment Keithley 6517, S/N 0598551 was used with a capacitive handheld probe for measuring the body-voltage. The following results were obtained:

| | | Average voltage of |
|---|---|---|
| | | trial participants*) |
| Climate | Shoe | in volts |
| 23° C., 50% rel. humidity | Standard sandal | 63 |
| | Town shoe | 107 |
| 23° C., 25% rel. humidity | Standard sandal | −902 |
| | Town shoe | −415 |

*)average of the highest minima

The results of the tests therefore showed that the panels manufactured according to the invention provide “astatic” behaviour as defined with reference to the standard IEC 1340-4-1, because under conditions of 23° C. and 50% relative humidity, and also 23° C. and 25% relative humidity, also with non-conductive backing, the average voltage of the trial participants did not exceed the value of 2 kV. According to IEC 1340-4-1, the term “astatic” behaviour is defined by a body-voltage of less than 2 kV. However, a method for measuring the body-voltage has not yet been defined. Accordingly, an unambiguous classification in accordance with this test standard is not permissible. However, the method according to the standard EN 1815 has been used and recognised for more than 20 years for the measurement of body-voltage when walking on various types of floor covering.

1-9. (canceled)

10. A floor panel comprising a substrate, a décor paper, an overlay, and abrasion-resistant particles, wherein the décor paper is pressed together with the substrate, wherein the overlay and abrasion-resistant particles are provided between the substrate and décor paper, and wherein the overlay and décor paper are soaked with a mixture comprising quaternary amines and at least one of a urea resin and a melamine resin.

11. The panel of claim 10, wherein the substrate comprises a timber product.

12. The panel of claim 10, wherein the substrate comprises high density fiberboard.

13. The panel of claim 10, wherein the abrasion-resistant particles have an average size of about 60 microns to about 120 microns.

14. The panel of claim 10, wherein the mixture is present in a concentration of about 150 g/m².

15. The panel of claim 10, wherein the abrasion-resistant particles are selected from the group consisting of corundum, aluminum oxide, and silicon carbide.

16. A floor panel comprising a substrate, a décor paper, an overlay, and abrasion-resistant particles, wherein the décor paper is pressed together with the substrate, wherein the overlay and abrasion-resistant particles are provided between the substrate and décor paper, and wherein the overlay and décor paper are soaked with a mixture comprising quaternary ammonium compounds and at least one of a urea resin and a melamine resin.
